(19) United States
(12) Patent Application Publication
(10) Pub. No.: US 2009/0265049 A1
(43) Pub. Date: Oct. 22, 2009

(54) AIRCRAFT SYSTEM EMISSIONS AND NOISE ESTIMATION MECHANISM

(75) Inventors: John A. Wise, Glendale, AZ (US); Dinkar Mylarswamy, Fridley, MN (US); Lysbeth Lieber, Tempe, AZ (US); Jiri Svoboda, Okr Novy Jicin (CZ); Petr Krupansky, Veverska Bityska (CZ); Silvie Luisa Brazdilova, Kurim (CZ)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/107,282

(22) Filed: Apr. 22, 2008

(51) Int. Cl. G06F 17/00

(52) U.S. Cl. 701/3

(57) ABSTRACT

A method for generating emissions estimations of an aircraft is provided. A plurality of aircraft parameters is gathered. A first parameter of the plurality of aircraft parameters is selected for a first model. The first model mathematically contributes to the formulation of a first emissions estimation. The first model is considered with a plurality of additional models in view of the plurality of aircraft parameters to obtain the first emissions estimation. The first emissions estimation is a composite representation of the first model and the plurality of additional models in view of the plurality of aircraft parameters.

### FIELD OF THE INVENTION

The present invention generally relates to aircraft systems, and more particularly, but not exclusively, to a system-level emissions prediction mechanism for aircraft.

### BACKGROUND OF THE INVENTION

Aircraft emissions, including hydrocarbon and noise emissions, are increasingly scrutinized by government, regulators, and industry alike. For example, the European Union (EU) has implemented several research programs in relation to these emissions in an attempt to reduce pollution, such as the programs coordinated under the Single European Skies ATM Research Program (SESAR). Governments are paying closer attention to the effect of aircraft emissions on the environment. As fuel costs have risen, industry has also paid closer attention to reducing fuel consumption and correspondingly reducing emissions.

Accordingly, it has become increasingly desirable to reduce aircraft emissions for a variety of reasons. One such approach for industry has been innovation in the design phase of aircraft, including the implementation of more lightweight materials in the airframe. In addition, control systems have become increasingly sophisticated.

Regulators have become increasingly interested in implementing schemes to reduce overall emissions and soften the environmental impact of air travel. These schemes generally involve the participation of ground-based air traffic management systems (ATMS) in the operation of the aircraft in flight. In addition, Standard Instrument Departure (SID) and Standard Terminal Arrival Routes (STAR) are increasingly being adopted, where a ATM controller may simply instruct the flight crew according to a particular SID or STAR, and the flight crew follows the SID or STAR's courses, headings and altitude limits. From a noise emissions standpoint, the maintenance of speed limits within the terminal area becomes important.

Accordingly, it is desirable to implement a mechanism whereby an ATMS may coordinate with aircraft to reduce total emissions in a particular region or over a period of time. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment, by way of example only, a method for generating emissions estimations of an aircraft is provided. A plurality of aircraft parameters is gathered. A first parameter of the plurality of aircraft parameters is selected for a first model. The first model mathematically contributes to the formulation of the first emissions estimation. The first model is considered with a plurality of additional models in view of the plurality of aircraft parameters to obtain the first emissions estimation. The first emissions estimation is a composite representation of the first model and the plurality of additional models in view of the plurality of aircraft parameters.

In another embodiment, by way of example only, a method for providing emissions estimations of an aircraft for datalink to an air traffic management system is provided. A plurality of aircraft parameters is gathered. A first parameter of the plurality of aircraft parameters is selected for a first model. The first model mathematically contributes to the formulation of a first emissions estimation. The first model is considered with a plurality of additional models in view of the plurality of aircraft parameters to obtain the first emissions estimation. The first emissions estimation is a composite representation of the first model and the plurality of additional models in view of the plurality of aircraft parameters. The first emissions estimation is provided to the air traffic management system. The air traffic management system analyzes the first emissions estimation with an additional emissions estimation to determine an appropriate flight plan for the aircraft.

In another embodiment, again by way of example only, a system for providing emissions estimations of an aircraft for datalink to an air traffic management system is provided. An estimation module is in communication with a flight management system of the aircraft and a plurality of aircraft sensors. The estimation module is configured for gathering a plurality of aircraft parameters. At least one of the plurality of aircraft parameters is obtained from at least one of the plurality of aircraft sensors. The estimation module is further configured for selecting a first parameter of the plurality of aircraft parameters is selected for a first model, the first model mathematically contributing to the formulation of a first emissions estimation. The estimation model is further configured for considering the first model with a plurality of additional models in view of the plurality of aircraft parameters to obtain the first emissions estimation, the first emissions estimation a composite representation of the first model and the plurality of additional models in view of the plurality of aircraft parameters. A communication module is coupled to the estimation module. The communication module is configured for receiving an emissions request from the air traffic management system for a proposed flight change for the aircraft, the proposed flight change providing at least one of the plurality of aircraft parameters, and in response to the emissions request, providing the first emissions estimation to the air traffic management system, the air traffic management system analyzing the first emissions estimation with an additional emissions estimation to determine an appropriate flight plan for the aircraft.

In still another embodiment, again by way of example only, a computer program product for providing emissions estimations of an aircraft for datalink to an air traffic management system is provided. The computer program product comprises a computer-readable storage medium having computer-readable program code portions stored therein. The computer-readable program code portions comprise a first executable portion configured for gathering a plurality of aircraft parameters, a second executable portion configured for selecting a first parameter of the plurality of aircraft parameters for a first model, the first model mathematically contributing to the formulation of a first emissions estimation, a third executable portion configured for considering the first model with a plurality of additional models in view of the plurality of aircraft parameters to obtain the first emissions estimation, the first emissions estimation a composite representation of the first model and the plurality of additional models in view of the plurality of aircraft parameters, and a fourth executable portion configured for providing the first emissions estimation to the air traffic management system, the air traffic management system analyzing the first emissions estimation with an additional emissions estimation to determine an appropriate flight plan for the aircraft.

### BRIEF DESCRIPTION OF THE DRAWINGS

The present invention will hereinafter be described in conjunction with the following drawing figures, wherein like numerals denote like elements, and

FIG. 1 illustrates an aircraft in communication with an air traffic management system;

FIG. 2 illustrates an exemplary block diagram of a mechanism for providing emissions estimations (calculated on the aircraft or on the ground) to an air traffic management system to determine an appropriate flight path;

FIG. 3 illustrates an exemplary block diagram of a plurality of models considered in view of a plurality of aircraft parameters to generate a hydrocarbon emissions estimation for an aircraft;

FIG. 4 illustrates an exemplary block diagram of a plurality of models considered in view of a plurality of aircraft parameters to generate a noise emissions estimation for an aircraft;

FIG. 6 illustrates an exemplary block diagram of a plurality of models considered in view of a plurality of aircraft parameters by an air traffic management system to determine an appropriate aircraft maneuver; and

FIG. 5 illustrates an exemplary method of providing emissions estimations to an air traffic management system to determine an appropriate flight path.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present description and following claimed subject matter present exemplary system, method, and computer program product embodiments of a mechanism to provide emissions estimations, including hydrocarbon, noise, or other emissions, to an air traffic management system to make informed decisions as to aircraft flight plans.

These embodiments gather a variety of aircraft parameters. The aircraft parameters may be collected offline, such as parameters related to configuration data of a particular aircraft. The aircraft parameters may be collected online, as the aircraft is in operation. In addition, other external parameters, such as weather data, wind speed data, weather forecast data, and the like, may be gathered.

The gathered parameters are analyzed in view of a collective number of mathematical models representative of at least a portion of the collective emissions estimation. By collectively analyzing a variety of these models, a composite emissions estimation may be obtained for a variety of aircraft scenarios. These scenarios may include a current operating state, an emissions-optimal scenario, an emissions estimation as a result of performing a requested flight plan change by the air traffic management system (ATMS), and an emissions estimation as a result of performing an inverse of the requested flight plan change.

In one embodiment, the emissions estimation(s) are provided to the ATMS for analysis. For example, in one embodiment, the ATMS may be responsible for a number of aircraft operating over a certain region. While monitoring the aircraft in flight, the ATMS may determine that the flight plans of two of the aircraft being monitored are in conflict. As a result, it may be necessary to change the flight plan of one or more aircraft to resolve the flight plan conflict.

Once a conflict is determined, the ATMS may contact one or more of the aircraft in conflict to request an emissions estimation(s). Use of the terms “request an emissions estimation(s)” is intended to be interpreted loosely. In other words, the emissions estimation requests may, as one skilled in the art will anticipate, take the form of a wide variety of requests for information relating to emissions in various forms. The mechanisms described below may operate in response to these emissions estimation requests. The emissions estimations may be provided to ATMS for the various scenarios described above. Emissions estimations may be received from all aircraft determined to be in conflict. Based on these estimations, the ATMS, the aircraft, an external system, or another mechanism may determine which of the aircraft should perform a flight plan change in order to reduce total emissions. In one embodiment, the ATMS may consider the most appropriate maneuver or flight plan change based on various emissions estimations. Appropriate maneuvers decision logic may be provided by an estimations module in communication with the ATMS. This ATM estimations module will be further described, following.

While the emissions estimations may be provided to the ATMS for analysis, the skilled artisan will appreciate that the analysis described above may be performed on board the aircraft or even elsewhere. For example, the ATMS may provide one or more proposed flight paths to the aircraft, based at least in part on current air traffic requirements. Systems on board the aircraft as will be further described may determine an appropriate flight plan based on the emissions estimations earlier generated. For example, in choosing an appropriate flight plan, the systems may determine which of a number of proposed flight plans have the lowest resulting emissions. The aircraft may then provide data representing the estimations analysis to the ATMS to obtain approval to select the appropriate flight path from the ATMS. A variety of additional scenarios may also be possible. In each scenario, systems on the aircraft may gather parameters, generate emissions estimations, and perform analysis. In some cases, it may be preferable for such analysis to be performed on the ground as facilitated by the ATMS. Again, the ATM estimations module may help facilitate such analysis.

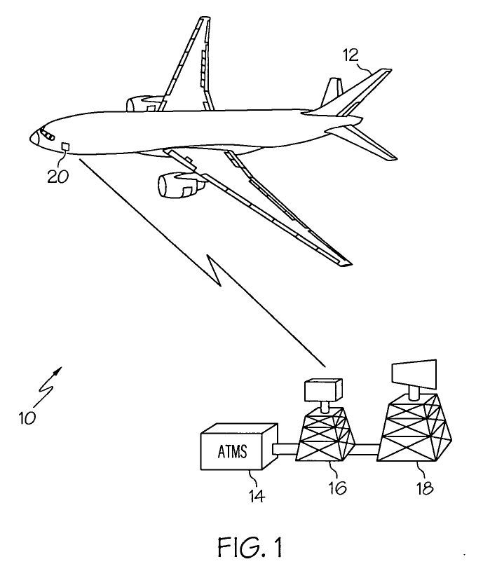

FIG. 1 illustrates an exemplary scenario 10 of an aircraft 12 in communication with an ATMS system 14. ATMS 14 sends and receives data to the aircraft 12 using transmission towers 16 and 18. An interactive relationship may be established between the aircraft 12 and the ATMS 14, whereby a variety of data may be uplinked and downlinked through a large bandwidth of communication. A variety of data may be sent to and received from the aircraft 12, including emissions estimation data, flight plan data, environmental data, and the like. As previously described, following the determination of a conflict, the ATMS 14 may request emissions estimation data from the aircraft 12. The estimation data may be calculated and generated by an estimations system 20 located onboard the aircraft 12. The estimation data may then be provided to the ATMS 14 via transmission towers 16 and 18. Based on the emissions estimates provided by the aircraft 12 and other aircraft 12 (not shown), the ATMS 14 may determine the aircraft and flight plan change which should be executed. The flight plan change may be selected upon additional communication about emissions estimations of selected maneuvers for conflict resolution, or it may be calculated on the ATMS side by usage of an ATM estimation module. The flight plan change may include a change of airspeed, a change of altitude, and the like, as one skilled in the art will anticipate. The ATMS 14 communicates this decision to the aircraft 12. The aircraft 12 then makes the appropriate flight plan change.

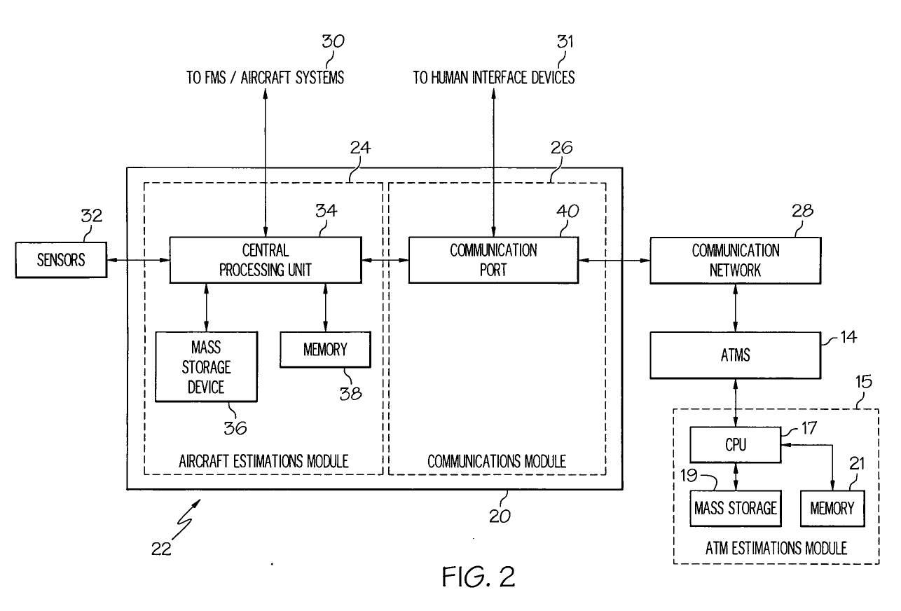

FIG. 2 illustrates an exemplary block diagram of a mechanism 22 for providing emissions estimations to an air traffic management system to determine an appropriate flight path, as well as a mechanism 22 for performing emissions analysis, depending on the applicable scenario. An estimations system 20 is depicted. The estimations system 20 includes an estimations module 24 coupled to a communications module 26. The communications module 26 is connected to a communication network 28 in communication with the ATMS system 14. As one skilled in the art will anticipate, the estimations system 20, including an aircraft estimations module 24 and a communications module 26 may comprise various existing components of aircraft systems, including flight management systems (FMS), engine control systems, aircraft communications systems, and the like. In fact, various portions of the estimations system 20 may not be collectively assembled together as shown, as estimations system 20 is depicted, at least in part, for conceptual purposes.

Emissions system 20 may be implemented in hardware, software, firmware, or a combination thereof. For example, portions of aircraft estimations module 24 may be implemented as a computer program product including a computer-readable storage medium having computer-readable program code portions stored therein. The computer-readable storage medium may include disk drives, flash memory, digital versatile disks (DVDs), compact disks (CDs), and other types of storage mediums. Estimations system 20 may utilize, and be compatible with, a variety of industry standards and specifications, including regulatory specifications provided by a particular regulatory body. Emissions system 20 may set up communication with various data feeders. For example, human interface devices 31 such as control panels, keyboard devices, and/or cursor control devices may be coupled through a suitable bus to the emissions system 20 through communication port 40. Similarly, a user application (not shown) may be operational on portions of the emissions system 20.

In view of the foregoing, the aircraft estimations module 24 is shown having a central processing unit (CPU) 34, a mass storage device 36 such as a hard disk drive (HDD), and a memory 38 such as non-volatile random access memory. The CPU 34 is shown coupled to a plurality of aircraft sensors 32. Likewise, the CPU 34 is shown coupled to the aircraft FMS or other aircraft systems. Again, the various components depicted in estimations module 24 may be integrated into a variety of existing aircraft systems. For example, the CPU 34 may be a CPU functioning as part of the aircraft's FMS, wherein a portion of the CPU's processing power is dedicated or allocated to handling emissions estimations calculations.

Emissions system 20 may utilize aircraft estimations module 24, or other computing components on board the aircraft or elsewhere (such as the ATM estimations module 15), to perform emissions analysis based on the emissions estimations. For example, emissions system 20 may implement estimations module 24 to determine an appropriate flight path of a number of possible flight paths. Emissions system 20 may perform other similar analysis of emissions estimation data as one skilled in the art will appreciate.

Communications module 26 is shown incorporating a communication port 40 coupled to the CPU 34. The communications module 26, including communication port 40, may comprise at least a portion of the aircraft's existing communication system with the ATMS 14. Communications module 26 is responsible for sending data to, and receiving data from, the ATMS 14 over communication network 28. Communications module 26 provides the emissions estimations data to the ATMS 14 in response to an emissions request. Communications module 26 may receive various parameters received from the ATMS 14 or elsewhere, which may be forwarded to the estimations module 24.

Aircraft estimations module 24, as well as ATM estimations module 15, are configured to gather a variety of aircraft parameters, including configuration parameters, operation parameters, environmental parameters, and the like. The aircraft parameters may be collected from a variety of sources, including the sensors 32, the FMS and other aircraft systems 30, the ATMS 14, and elsewhere. In one embodiment, the estimations module 24 stores a variety of communications protocols, mathematical models, definitions, parameters, indexes, lookup tables, databases, data fitting algorithms, and the like. These models, parameters, definitions, algorithms, etc., may be stored on memory 38 or mass storage device 36. CPU 34 may execute instructions to consider the various models in view of the number of aircraft parameters. The aircraft parameters may be selected for a particular model, as will be further described. The emissions estimation becomes a composite representation of the mathematical models in view of the aircraft parameters supplied to the models.

While the emissions system 20 is depicted on board the aircraft, it will be appreciated that the at least portions of system 20 may be located externally to the aircraft, such as integrated into the ATMS system itself, or located externally to the aircraft and to the ATMS. In fact, a dedicated system 20 for performing emissions estimations and analysis may be located apart from the aircraft and/or the ATMS. The system 20 may receive data from both the aircraft and from ATMS to generate emissions estimations and perform various emissions analysis. While this embodiment is not specifically illustrated, it is contemplated by the present invention. Regardless of where portions of system 20 is located, it will be appreciated that system 20 collectively gathers parameters, generates emissions estimations, and performs emissions analysis.

ATM estimations module 15 is shown in communication with the ATMS 14 for providing emissions estimations and for facilitating the ATMS to determine an appropriate flight plan for various embodiments featuring calculation functionality on the ATM side. The ATM estimations module 15 includes a CPU 17 in communication with a mass storage device 19 and memory 21. ATM estimations module 15 may function in similar fashion to the aircraft estimations module 24 located on board the aircraft. For example, estimations of past emissions may be preferable to be calculated on the aircraft estimations module 24, and downlink. Estimations of future emissions may be preferable to be calculated on the ATM side (facilitated by the ATM estimations module 15) for the selection of an appropriate aircraft maneuver.

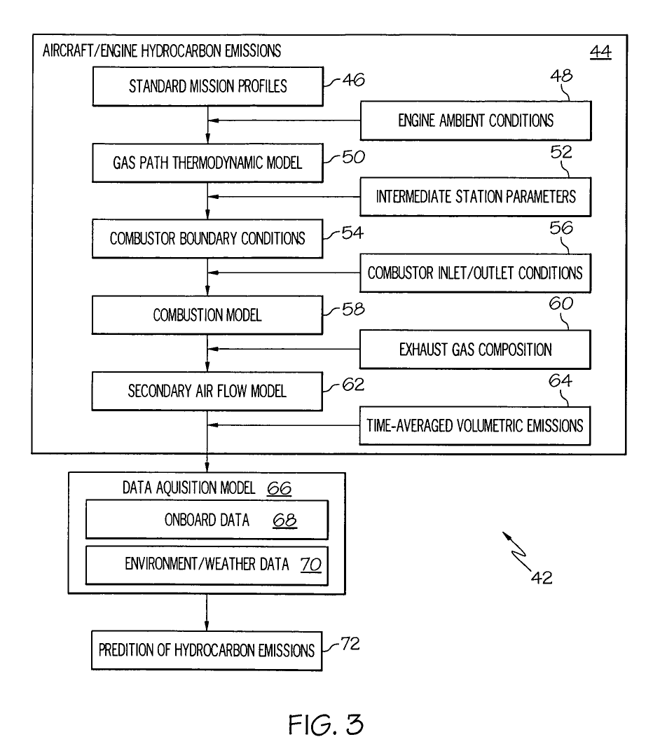

FIG. 3 illustrates an exemplary block diagram 42 of a plurality of models considered in view of a plurality of aircraft parameters to generate a hydrocarbon emissions estimation for an aircraft. As one skilled in the art will appreciate, while the various models depicted may be useful in the composite determination of hydrocarbon emissions, the methodology described is by no means exclusive. For example, additional models and corresponding aircraft parameters may be considered in a particular implementation.

A block of aircraft/engine hydrocarbon emissions models 44 may be configured as shown. The block 44 may include models related to particular aspects of an emissions estimation. For each of the various models, various aircraft parameters may be selected and thereby considered. Standard mission profiles model 46 may be developed to then consider a variety of engine ambient conditions 48, for example. The engine ambient conditions may include such parameters as inlet pressure, inlet temperature, mach number, power level position, and altitude. A gas path thermodynamic model 50 may take into account a variety of intermediate station parameters 52, such as exhaust gas temperature, fuel flow, compressor pressure, inter-stage pressure, fan speed, core shaft speed, and bleed positions.

Combustor boundary conditions 54 may take into account combustor inlet/outlet condition parameters 56. A combustion model 58 may take into account exhaust gas composition parameters 60. A secondary air flow model 62 may take into account time-averaged volumetric emissions parameters 64.

An additional data acquisition model 66 may be then considered. The data acquisition model may take into account various on-line parameters, such as onboard measurement data 68, and environment/weather data 70 such as wind speed, weather forecast data, and the like.

To formulate a hydrocarbon emissions estimation 72, each of the various models may be considered in light of selected aircraft parameters. Some models may be given additional mathematical weight depending on the importance of the model to the overall estimation, for example. Calculations may be normalized to account for various factors. Historical data may be taken into account, such as emissions data previously collected. The historical data may be utilized to compare expected emissions estimations with actual emissions recorded to reduce error. A final hydrocarbon emissions estimation may be formulated by cross referencing calculations in an emissions lookup table, or by a similar method. A variety of methods may be implemented, none of which may be exclusive to a final emissions determination.

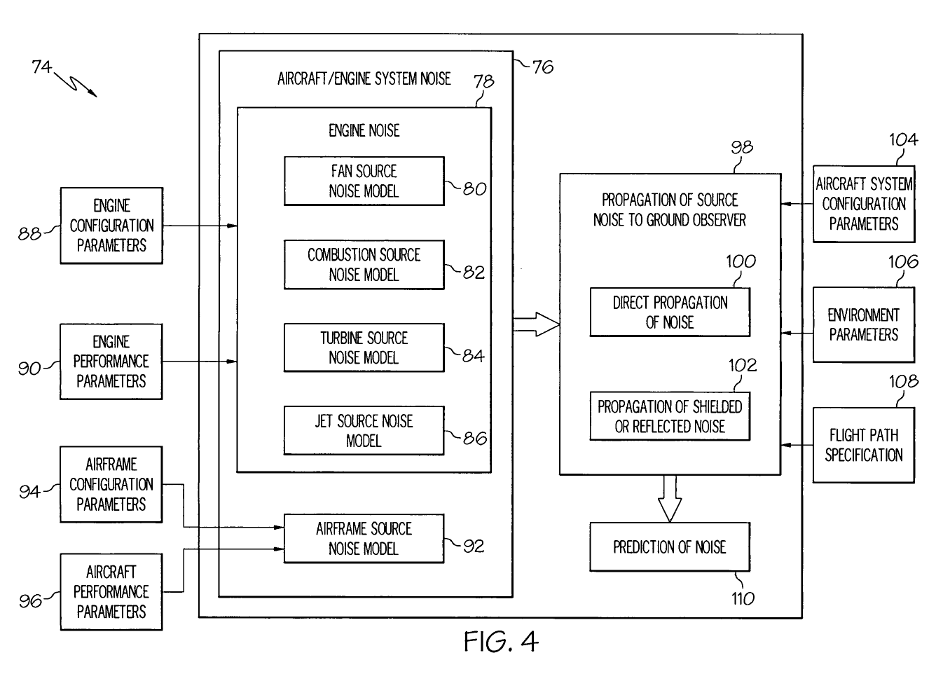

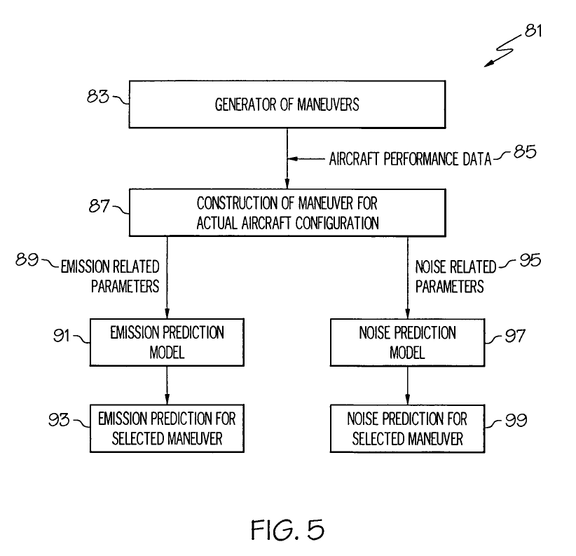

In a similar fashion to the blocks depicted in FIG. 3, FIG. 4 illustrates an exemplary block diagram 74 of a plurality of models considered in view of a plurality of aircraft parameters to generate a noise emissions estimation for an aircraft. In a similar methodology to that described in FIG. 3, blocks of models representative of various aspects of noise emissions may be grouped and considered. In the exemplary diagram of FIG. 4, an aircraft/engine system noise block 76 includes consideration of an engine noise block 78 and an airframe source noise model 92. Engine noise block 78 includes a fan source noise model 80, a combustion source noise model 82, a turbine source noise model 84, and a jet source noise model 86. The engine noise considerations take into account engine configuration parameters 88 and engine performance parameters 90.

Specific engine configuration parameters may be selected by the estimations module to be considered in a particular emissions model. Examples of engine configuration parameters 88 selected for the fan source noise model 80 of engine noise block 78 include such configuration parameters 88 as a number of fan stages, a number of fan rotor blades, a number of fan stator vanes, a rotor-stator axial spacing measurement, a fan tip diameter, a fan hub diameter, a fan relative tip mach number at design point, and a fan acoustic treatment attenuation spectra. In one embodiment, the engine configuration parameters 88 are obtained in advance and stored on the estimations module, or elsewhere.

Examples of engine performance parameters 90 selected for the fan source noise model 80 of engine noise block 78 include a fan inlet mass flow, a fan revolution per minute (RPM), a total temperature measurement of a fan inlet, and a total temperature measurement of a fan exit. In one embodiment, these engine performance parameters 90 are obtained from an aircraft engine computer and/or sensors aboard the aircraft as previously indicated.

An example of an engine configuration parameter 88 selected for the combustion source noise model 82 of engine noise block 78 includes a total temperature extraction by turbine, at maximum takeoff condition parameter.

Examples of engine performance parameters 90 selected for the combustion source noise model 82 of engine noise block 78 include a combustor inlet mass flow, a total temperature measurement of a combustor inlet, a total pressure measurement of a combustor inlet, and a total temperature measurement of a turbine inlet. These engine performance parameters may, again, be obtained from an aircraft engine computer and/or sensors aboard the aircraft.

Examples of engine configuration parameters 88 selected for the turbine source noise model 84 of engine noise block 78 include an axial turbine tip diameter, at exit, an axial turbine hub diameter, at exit, and a number of turbine rotor blades. Examples of engine performance parameters 90 selected for the turbine source noise model 84 of engine noise block 78 include a turbine revolutions per minute (RPM), and a turbine section pressure ratio (total-to-static).

For the jet source noise model 86 of the engine noise block 78, examples of engine configuration parameters 88 may include a core jet outer diameter, a core jet annular height, a bypass jet outer diameter, a bypass jet annular height, an axial distance from a bypass nozzle exit plane to core nozzle exit plane, a core pressure ratio, a core nozzle physical area, and a bypass nozzle physical area. Examples of engine performance parameters 90 for the jet source noise model 86 include a fully expanded core jet velocity measurement, a fully expanded bypass jet velocity measurement, a total temperature measurement of the core jet, and a total temperature measurement of the bypass jet.

Airframe source noise model 92 takes into account various selected airframe configuration parameters 94 and aircraft performance parameters 96. Examples of airframe configuration parameters 94 for this model 92 include landing gear component dimensions, a number of wheels (main and nose gear), a wing span, a wing area, a flap span, a flap area, a horizontal tail span, a horizontal tail area, a vertical tail span, and a vertical tail area.

Once aircraft and airframe configuration and performance parameters are selected and considered in the various engine and airframe models, the methodology described in block diagram 74 moves to block 98, referring to the formulation of a mechanism to describe the propagation of source noise to a ground observer. The noise propagation 90 may include direct noise propagation 100 or propagation of shielded or reflected noise 102. A consideration of noise propagation modes includes the selection of various aircraft system configuration parameters 104, environment parameters 106, and flight path specification parameters 108.

Examples of aircraft system configuration parameters 104 include a number of engines, wing panel coordinates, and an engine orientation. Examples of environment parameters 106 include ambient temperature, ambient pressure, and relative humidity. Finally, examples of flight path specification parameters include aircraft flight speed, aircraft flight path angle (climb or decent angle), angle of attack, and altitude parameters.

In similar fashion to the methodology depicted in FIG. 3, the various models are considered in light of the selected parameters (including a consideration of historical and/or measured data where appropriate) to form a composite noise emissions estimation/prediction 110.

In similar fashion to the functionality depicted in FIGS. 3 and 4, FIG. 5 is an exemplary block diagram 81 of the considerations of an ATM emissions module 15 (FIG. 2) to perform maneuver considerations as previously described. The ATM includes functionality to generate aircraft maneuvers, as depicted by maneuver block 83. Maneuver block 83 takes into consideration aircraft performance and flight path data 85 to construct a maneuver for an actual aircraft configuration (represented by construction block 87). An emission prediction module 91 is analyzed in view of various emission related parameters 89. Similarly, a noise prediction model 97 is analyzed in view of noise related parameters 95. From the emission prediction model 91, an emission prediction for the selected (constructed) maneuver is generated (represented by emission block 93). Similarly, from the noise prediction model 97, a noise prediction for the selected (constructed) maneuver is generated (represented by noise block 99). The noise and emissions predictions are provided to the ATMS for analysis.

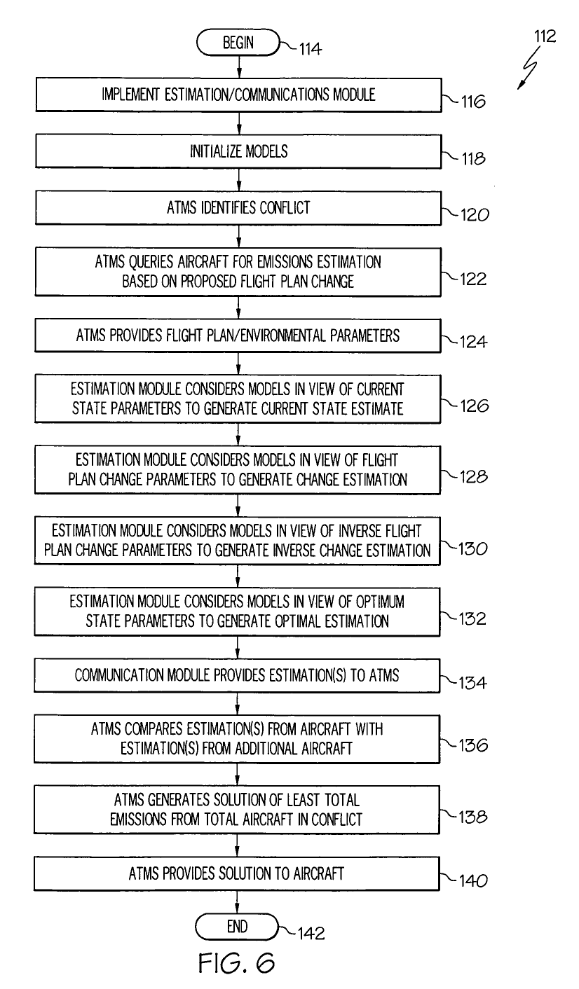

FIG. 6 illustrates an exemplary method 112 of providing emissions estimations to an air traffic management system to determine an appropriate flight path. As one skilled in the art will appreciate, various steps in the method 112 may be implemented in differing ways to suit a particular application. For example, various steps in the method 112 may be omitted, modified, or may be carried out in differing orders. In an embodiment where emissions analysis is performed on board the aircraft, or elsewhere, and forwarded to the ATMS, it will be appreciated that various steps in the method 112 may be modified to reflect such an embodiment. In addition, various steps may be implemented by differing means, such as by hardware, firmware, or software, or a combination thereof operational on, or associated with, the emissions system 20 previously described (FIG. 2).

Method 112 begins (step 114) with the implementation of an estimation and a communications module as part of an overall estimations system onboard the aircraft (step 116). Once the framework for calculating emissions estimations is functional, the various models representative of aspects of an overall emissions estimation may be constructed and initialized (step 118). In addition, various selected aircraft/airframe/system performance, configuration and environmental parameters may be gathered.

Meanwhile, an ATMS is monitoring the aircraft among a number of aircraft. The ATMS detects a conflict (step 120) as previously described, for example. The ATMS queries the aircraft for emissions estimation(s) based on a proposed flight plan change (step 122). The flight plan change may include a request to increase speed by 5 knots, for example.

Flight plan change data may accompany the flight plan change emissions request (step 124). The flight plan change specification data and/or other environment parameters are provided to the estimations system for consideration along with the various additional selected parameters.

In the depicted embodiment, the estimations system begins the process of generating a number of estimates, based on various aircraft parameters. The first estimation is generated based on aircraft current state parameters (step 126). The next estimation is based on parameters that change as a result of the flight plan change (step 128). The following estimation is based on the inverse of changed parameters due to the flight plan change, generating an inverse emissions estimation (step 130). Finally, an optimum estimation may be generated based on an optimum set of parameters (step 132).

The various emissions estimations are provided to the ATMS for analysis (step 134). The ATMS compares the estimations received from the instant aircraft with estimations received from other aircraft determined to be in conflict with each other (step 136). Based on this analysis, the ATMS generates a solution resolving the conflict resulting in the least total emissions of all aircraft involved (step 138). The solution may be to request the flight plan change initially queried to the instant aircraft (step 140). Here again, it may be preferable for such flight plan calculations to occur on the ATM side, as facilitated by the ATM estimations module. The method 112 then ends (step 142).

Some of the functional units described in this specification have been labeled as “modules” in order to more particularly emphasize their implementation independence. For example, functionality labeled as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for generating emissions estimations of an aircraft, comprising:
gathering a plurality of aircraft parameters;
selecting a first parameter of the plurality of aircraft parameters for a first model, the first model mathematically contributing to the formulation of a first emissions estimation;
considering the first model with a plurality of additional models in view of the plurality of aircraft parameters to obtain the first emissions estimation, the first emissions estimation a composite representation of the first model and the plurality of additional models in view of the plurality of aircraft parameters.

2. The method of claim 1, wherein gathering a plurality of aircraft parameters includes gathering real-time flight data from a plurality of aircraft sensors, and gathering weather parameters associated with the aircraft.

3. The method of claim 1, further including analyzing the first emissions estimation in view of a proposed flight plan of the aircraft, the proposed flight plan contributing at least one of the plurality of aircraft parameters.

4. The method of claim 3, further including:
generating a second emissions estimation based on a current state of the aircraft, and
comparing the second emissions estimation with the first emissions estimation to determine which of the current state of the aircraft or the proposed flight plan change results in lower aircraft emissions.

5. The method of claim 4, further including:
generating a third, inverse emissions estimation based on at least one aircraft parameter representing an inverse of the proposed flight plan, and
comparing the third emissions estimation with the first and second emission estimations to determine which of the current state of the aircraft, the proposed flight plan change, or the inverse of the proposed flight plan results in lower aircraft emissions.

6. A method for providing emissions estimations of an aircraft for datalink to an air traffic management system, comprising:
gathering a plurality of aircraft parameters;
selecting a first parameter of the plurality of aircraft parameters for a first model, the first model mathematically contributing to the formulation of a first emissions estimation;
considering the first model with a plurality of additional models in view of the plurality of aircraft parameters to obtain the first emissions estimation, the first emissions estimation a composite representation of the first model and the plurality of additional models in view of the plurality of aircraft parameters; and
providing the first emissions estimation to the air traffic management system, the air traffic management system analyzing the first emissions estimation with an additional emissions estimation to determine an appropriate flight plan for the aircraft.

7. The method of claim 6, further including receiving an emissions request from the air traffic management system for a proposed flight plan change for the aircraft, the proposed flight plan change supplying at least one of the plurality of aircraft parameters.

8. The method of claim 7, further including subsequent to receiving the emissions request:
generating a second emissions estimation to compare with the first emissions estimation, the first emissions estimation based on the proposed flight plan change and the second emissions estimation based on a current flight state of the aircraft,
generating a third, inverse emissions estimation to compare with the first emissions estimation, the third, inverse emissions estimation based on at least one aircraft parameter representing an inverse of the proposed flight plan, and
providing the second and third emissions estimations to the air traffic management system along with the first emissions estimation.

9. The method of claim 8, further including generating a fourth, optimal emissions estimation based on an emissions-optimal set of the plurality of aircraft parameters.

10. The method of claim 6, wherein considering the first model with a plurality of additional models to obtain the emissions estimation includes cross referencing the plurality of aircraft parameters with an emissions lookup table representative of the first model and the plurality of additional models.

11. The method of claim 6, wherein gathering a plurality of aircraft parameters includes gathering real-time flight data from a plurality of aircraft sensors.

12. The method of claim 6, wherein gathering a plurality of aircraft parameters includes gathering weather parameters associated with the aircraft.

13. A system for providing emissions estimations of an aircraft for datalink to an air traffic management system, comprising:
an estimation module in communication with a flight management system of the aircraft and a plurality of aircraft sensors, the estimation module configured for:
gathering a plurality of aircraft parameters, at least one of the plurality of aircraft parameters obtained from at least one of the plurality of aircraft sensors,
selecting a first parameter of the plurality of aircraft parameters for a first model, the first model mathematically contributing to the formulation of a first emissions estimation,
considering the first model with a plurality of additional models in view of the plurality of aircraft parameters to obtain the first emissions estimation, the first emissions estimation a composite representation of the first model and the plurality of additional models in view of the plurality of aircraft parameters; and
a communication module coupled to the estimation module, the communication module configured for:
receiving an emissions request from the air traffic management system for a proposed flight change for the aircraft, the proposed flight change providing at least one of the plurality of aircraft parameters, and
in response to the emissions request, providing the first emissions estimation to the air traffic management system, the air traffic management system analyzing the first emissions estimation with an additional emissions estimation to determine an appropriate flight plan for the aircraft.

14. The system of claim 13, wherein the estimation module is further configured for, subsequent to receiving the emissions request:
generating a second emissions estimation to compare with the first emissions estimation, the first emissions estimation based on the proposed flight plan change and the second emissions estimation based on a current flight state of the aircraft,
generating a third, inverse emissions estimation to compare with the first emissions estimation, the third, inverse emissions estimation based on at least one aircraft parameter representing an inverse of the proposed flight plan, and
providing the second and third emissions estimations to the air traffic management system along with the first emissions estimation.

15. The system of claim 13, wherein the estimation module is further configured for cross referencing the plurality of aircraft parameters with an emissions lookup table representative of the first model and the plurality of additional models.

16. The system of claim 13, wherein the plurality of aircraft parameters includes at least one of engine configuration parameters, engine performance parameters, airframe configuration parameters, aircraft performance parameters, aircraft system configuration patterns, and environment parameters.

17. The system of claim 13, wherein the plurality of aircraft parameters includes historical parameters associated with the aircraft recorded over a period of time.

18. The system of claim 13, wherein the aircraft parameters are related to hydrocarbon emissions of the aircraft, and the first model mathematically contributes to the formulation of a hydrocarbon emissions estimation.

19. The system of claim 13, wherein the aircraft parameters are related to noise emissions of the aircraft, and the first model mathematically contributes to the formulation of a noise emissions estimation.

20. The system of claim 18, wherein the plurality of aircraft parameters include at least one of engine inlet pressure, engine inlet temperature, mach number, power level position, altitude, exhaust gas temperature, fuel flow, compressor pressure, inter-stage pressure, fan speed, core shaft speed, bleed positions, combustor inlet conditions, combustor outlet conditions, exhaust gas composition, and time-averaged volumetric emissions.

21. The system of claim 18, wherein the first model is a gas path thermodynamic model, an onboard data acquisition model, a combustor boundary conditions model, a combustion model, or an air flow model.

22. The system of claim 19, wherein the plurality of aircraft parameters include at least one of a number of fan stages, a number of fan rotor blades, a number of fan stator vanes, a rotor-stator axial spacing, a fan tip diameter, a fan hub diameter, a fan relative tip mach number, a fan acoustic treatment attenuation spectra, a fan inlet mass flow, a fan revolution per minute (RPM), a fan inlet temperature, a fan exit temperature, a turbine temperature, a combustor inlet mass flow, a combustor inlet temperature, a combustor inlet pressure, a turbine inlet temperature, an axial turbine tip diameter, an axial turbine hub diameter, a number of turbine rotor blades, a turbine revolution per minute (RPM), and a turbine section pressure ratio.

23. The system of claim 19, wherein the plurality of aircraft parameters include at least one of a core jet outer diameter, a core jet annular height, a bypass jet outer diameter, a bypass jet annular height, an axial distance from a bypass nozzle exit plane to core nozzle exit plane, a core pressure ratio, a bypass pressure ratio, a core nozzle physical area, a bypass nozzle physical area, a fully expanded core jet velocity, a fully expanded bypass jet velocity, a core jet temperature, and a bypass jet temperature.

24. The system of claim 19, wherein the plurality of aircraft parameters include at least one of a landing gear component dimension, a number of wheels, a wing span, a wing area, a flap span, a flap area, a horizontal tail span, a vertical tail span, a horizontal tail area, a vertical tail area, a landing gear position, and a flap setting.

25. The system of claim 19, wherein the plurality of aircraft parameters include at least one of a number of engines, wing panel coordinates, an engine orientation, an ambient temperature, an ambient pressure, a relative humidity, an aircraft flight speed, an aircraft flight path angle, an angle of attack, an aircraft altitude.

26. A computer program product for providing emissions estimations of an aircraft for datalink to an air traffic management system, the computer program product comprising a computer-readable storage medium having computer-readable program code portions stored therein, the computer-readable program code portions comprising:
a first executable portion configured for gathering a plurality of aircraft parameters;
a second executable portion configured for selecting a first parameter of the plurality of aircraft parameters for a first model, the first model mathematically contributing to the formulation of a first emissions estimation;
a third executable portion configured for considering the first model with a plurality of additional models in view of the plurality of aircraft parameters to obtain the first emissions estimation, the first emissions estimation a composite representation of the first model and the plurality of additional models in view of the plurality of aircraft parameters; and
a fourth executable portion configured for providing the first emissions estimation to the air traffic management system, the air traffic management system analyzing the first emissions estimation with an additional emissions estimation to determine an appropriate flight plan for the aircraft.

27. The computer program product of claim 26, further including a fifth executable portion configured for processing an emissions request from the air traffic management system for a proposed flight plan change for the aircraft, the proposed flight plan change supplying at least one of the plurality of aircraft parameters.

28. The computer program product of claim 27, further including a sixth executable portion configured for, subsequent to processing the emissions request:
generating a second emissions estimation to compare with the first emissions estimation, the first emissions estimation based on the proposed flight plan change and the second emissions estimation based on a current flight state of the aircraft,
generating a third, inverse emissions estimation to compare with the first emissions estimation, the third, inverse emissions estimation based on at least one aircraft parameter representing an inverse of the proposed flight plan, and
providing the second and third emissions estimations to the air traffic management system along with the first emissions estimation.

29. The computer program product of claim 28, further including a seventh executable portion configured for generating a fourth, optimal emissions estimation based on an emissions-optimal set of the plurality of aircraft parameters.
